(19) United States
(12) Patent Application Publication
(10) Pub. No.: US 2005/0193565 A1
(43) Pub. Date: Sep. 8, 2005

(54) Self-defense ring

(76) Inventor: Charles Ray Knowles, Clinton, NC (US)

Correspondence Address: Frank W. Leak, Jr., P.O. Drawer 2428, Hickory, NC, 28603-2428, US

(21) Appl. No.: 11/061,177

(22) Filed: Feb. 18, 2005

Related U.S. Application Data
(60) Provisional application No. 60/546,294, filed on Feb. 20, 2004.

(51) Int. Cl. B26B 3/06

(52) U.S. Cl. 30/155

(57) ABSTRACT

A device used in self defense comprising a ring adapted to be worn on the little finger of the user and further comprising a top and a base. The base comprises a retractable blade mounted thereto that when fully deployed extends from the base of the ring in a direction opposite from the ring finger of the user.

### CROSS REFERENCE TO RELATED APPLICATIONS

This application claims the benefit of co-pending provisional application Ser. No. 60/546,294 in accordance with 35 U.S.C. 119(e).

### FIELD OF THE INVENTION

This invention relates to rings used in personal defense during physical attack comprising a retractable blade.

### BACKGROUND OF THE INVENTION

Police officers and other law enforcement officials are commonly exposed to violent members of the public. Whether arresting a violent criminal or making a seemingly harmless road side stop, police officers are increasingly under a threat that the person they encounter will attempt to take their side arm by force. An officer who loses that struggle is left at the mercy of the perpetrator. Typically an officer has his hand on or near the handle of his side arm when he approaches a suspect for ease and quickness of deploying his side arm and to protect the side arm from being acquired by the suspect. As is often the case, the suspect will lunge quickly forward and grab the officer's hand or wrist that is protecting the weapon. The officer is left trying to fend off the attack with one free hand while covering the side arm with his gun hand. There exists a need for an easily concealed simple weapon which can be conveniently deployed with little effort and which when used effectively causes the perpetrator to think about his or her own protection during such struggles. The usefulness of these weapons extends beyond the situation described above. For example, it is anticipated that such weapons would be useful in situations involving sexual assault, robbery, or other instances involving personal physical attack.

Rings which can be worn on the hands of a user and which can be employed for self defense purposes are known in the art. U.S. Pat. No. 5,888,214 describes a self defense ring assembly comprising a pair of rings integrally joined together and receivable on two juxtaposed fingers of a user. A center portion which connects the two rings includes a hollow interior which houses a manually retractable blade. Another self defense ring which uses a sharpened blade is described in U.S. Pat. No. 5,301,432. The top of this ring has a movable crown member with an elongate slot formed therein. A sharpened blade is arranged within the slot and mounted therein by first and second pin members. First and second pin members also pivot the blade from a retracted position to an open extended position when crown is moved. The blade extends upward from the top of the ring when the blade is open and exposed.

Each of the above-described self defense rings provide some degree of defense capability; however, there are notable characteristics inherent in the designs that reduce the defense potential and/or safety of the weapon. For example, problems have been observed with the accessibility of the release mechanisms, which often require unnecessary and wasteful motion on the part of the wearer to deploy the blade. Another problem is that blades that are left exposed to any degree when retracted cause safety concerns for the wearer and others. Blades positioned on the posterior part or “back” of the hand or finger have proven cumbersome to use effectively when under attack. Finally, blades that cannot be locked in a deployed state may result in untimely retraction and a certain amount of give to the blade when external pressure is applied leading to diminished defensive effectiveness.

### SUMMARY OF THE INVENTION

The present invention relates to a self defense ring that is comfortable and aesthetically pleasing, with greatly improved defensive potential. The present invention addresses the problems set forth above by providing a ring adapted to be worn on a single finger, preferably the little finger of either hand. The self defense ring has a top and a base. The base may have at least an outer face, an inner face, and a bottom face. The ring is worn similarly to ordinary ornamental rings, but when worn properly, the base is positioned beneath the little finger and the top rests on top of the little finger. The base of the present invention may be equipped with a retractable blade that when deployed extends away from the other fingers of the same hand. Preferably, the fully deployed blade extends in the opposite direction from the ring finger of the same hand.

In one embodiment of the invention, the base may contain a retractable blade housing mounted therein. A blade is slidably mounted within the retractable blade housing enclosing said blade therein when the blade is in a closed position. In this embodiment, the outer face of the base has a slot, which allows the blade to pass freely through when the blade is either being deployed or retracted. The retractable blade housing, in this embodiment also has a locking lever assembly, which through its interaction with the blade, both deploys the blade and also locks the blade in open and/or closed positions. A lever press is positioned on the face of the base nearest the ring finger of the same hand, known as the inner face and therefore is conveniently accessible to the thumb of the same hand.

The present invention may also be equipped with a safety to prevent accidental deployment of the retractable blade. In one embodiment, the safety is a rotating safety lever positioned and mounted to the top of the lever press. When the safety lever is open, a cylindrical pivot on the lever press's upper surface may engage a slot positioned on the ring's surface above the lever press when the lever press is pressed upward. In an alternative embodiment, the safety is a slide lever also mounted to the lever press.

In another embodiment of the present invention, the retractable blade may be a side-swinging design. In this embodiment, when in a closed position, the retractable blade lies against the ring's surface at the ring's base. The blade is mounted to the ring at a pivot point on the ring's surface. The blade pivots about the pivot point rotating the blade approximately 180 degrees to an open or closed position depending on its starting position. This retractable blade configuration may additionally have a retractable pin or bearing embedded within the surface of the ring. When the blade is open, the pin or bearing engages an aperture on the blade to secure the blade and effectively hold the blade in an open position.

In order to stabilize the ring and avoid rotation of the ring about the little finger when the ring is being used in self defense, the ring may be equipped with a recessed area on the side nearest the ring finger. The ring is stabilized through the application of pressure by the ring finger on recessed area when the wearer clinches his fist.

### BRIEF DESCRIPTION OF THE DRAWINGS

Having thus described the invention in general terms, reference will now be made to the accompanying drawings, which are not necessarily drawn to scale, and wherein:

FIG. 1A-B depicts a ring in accordance with one embodiment of the invention;

FIG. 2 illustrates the individual components of the retractable blade housing and retractable blade in accordance with one embodiment of the present invention.

FIG. 3 is a magnified overhead view of the retractable blade housing with the retractable blade locked in a fully deployed position in accordance with one embodiment of the present invention;

FIG. 4A-B illustrates an alternative embodiment of the self defense ring, including one embodiment of the safety assembly;

FIG. 5A-B depicts a ring equipped with a slide lever safety in accordance with one embodiment of the present invention;

FIG. 6A-B depicts a ring equipped with a rotating safety lever in accordance with one embodiment of the present invention;

FIG. 7A-C illustrates an alternative embodiment of the self defense ring retractable blade.

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

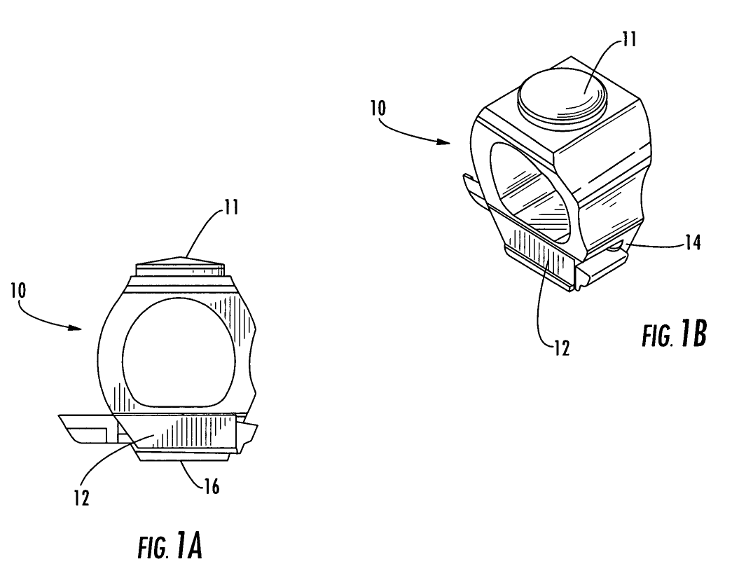

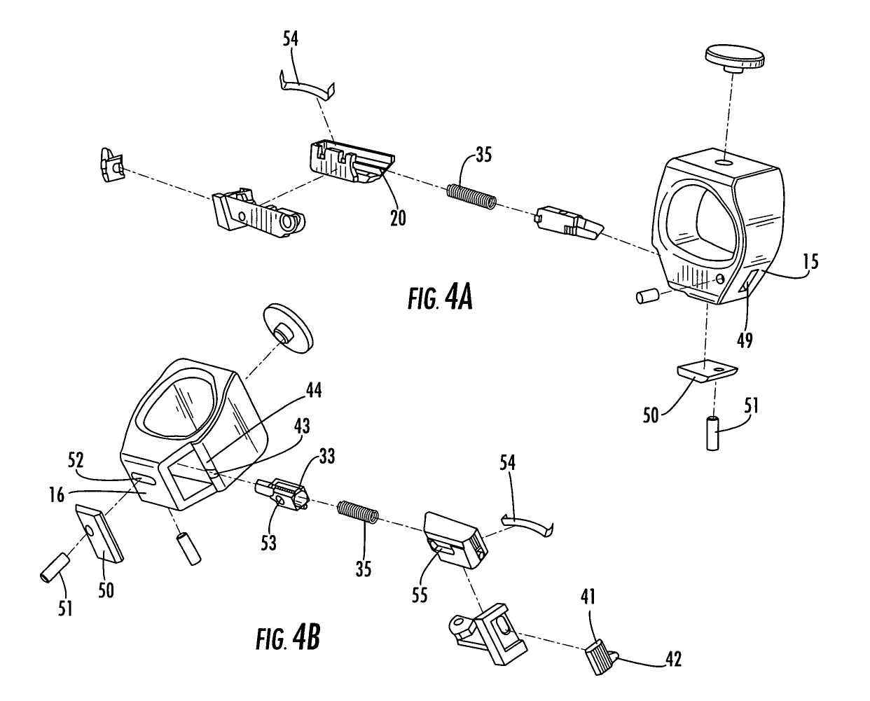

A ring 10 in accordance with one embodiment of the invention is depicted in FIG. 1. The ring is generally designed to be worn on the little finger of either hand. The basic components of the ring generally are a top 11 and a base 12. The base of the present invention is generally equipped with a retractable blade 13 that when deployed or open, extends away from the other fingers of the same hand. The base 12 generally contains at least three faces, an inner face 14, an outer face 15, and a bottom face 16. The bottom face 16 and the outer face 15 are best illustrated in FIG. 4. The inner face 14 is oriented such that the face points generally in the direction of the thumb of the same hand and is therefore accessible to interaction with the thumb. The outer face 15 is oriented such that the face points generally away from the fingers of the same hand.

The ring 10 generally has a central longitudinal axis extending through the center point of said ring from the top 11 down through the base 12 of ring 10. Generally, the retractable blade 13 of the present invention, when fully deployed, extends away from the other fingers of the same hand, and is further preferably positioned at an angle of about 45 to about 135 degrees relative to the central longitudinal axis of the ring. Preferably the fully deployed blade is positioned at an angle of about 60 to about 120 degrees relative to the central longitudinal axis of the ring. Most preferably the fully deployed blade is positioned at an angle of about 90 degrees relative to the central longitudinal axis of the of the ring 10. The choice of blade angle may be influenced by a number of factors, including blade design and/or retraction mechanism implemented.

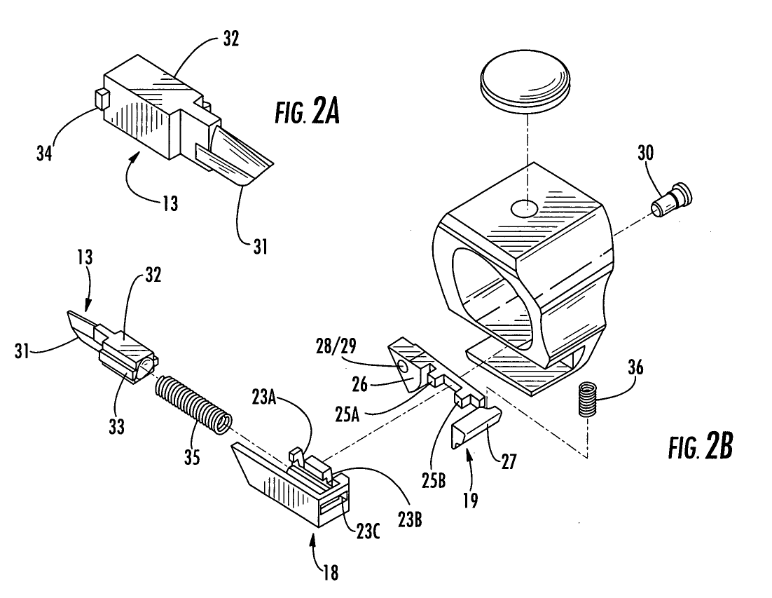

In one embodiment, the base 12 is partially composed of a retractable blade housing 17 mounted within base 12, as illustrated in FIGS. 1-4. The retractable blade housing 17 may be an insert, which fits inside base 12 of ring 10 as illustrated in FIG. 4 or retractable blade housing may be a component of the base with one side of the housing forming one of the sides of base 12 as illustrated in FIGS. 1-2. In this embodiment, the retractable blade housing 17 has two primary components, a sleeve 18 which cradles the blade and allows the blade to slide freely therein and a locking lever assembly 19 which engages the sleeve to form the housing 17. The sleeve 18 has a groove 20 that engages a ridge 33 located on one side of retractable blade 13. Groove 20 is best illustrated in FIG. 4 and ridge 33 is best illustrated in FIGS. 2 and 4. The blade is allowed to slide along the path dictated by the direction and the dimensions of groove 20. Sleeve 18 contains two vertical slots, slots 23A 23B, respectively on one of its sides. Slots 23A,B engage complementary structures on the locking lever assembly 19 in order to form a complete retractable blade housing. The sleeve additionally contains horizontal slot 23C on its inner side 24. The locking lever assembly 19 generally has two detents 25A and 25B, a stop 26 and a lever press 27. Detents 25A and B engage vertical slots 23A and B, respectively, on sleeve 16 to form housing 13, but the contact is such that slight upward and downward movement may occur therein. Lever press 27 engages horizontal slot 23C. Similarly, the contact between lever press 27 and slot 23C is such that slight upward and downward movement may occur therein. Stop 26 has a pivot point 28, which is defined by an aperture 29. Aperture 29 receives assembly pin 30. The contact between assembly pin 30 and aperture 29 both secures the retractable blade housing in place and allows for pivot motion of locking lever assembly 19.

The retractable blade 13 generally has a blade 31, and a base 32. See FIG. 2. The blade 13 generally can be any design and shape. For example, suitable blade designs include hawksbill, a standard knife, or a straight blade. The blade 31 may be any suitable length as long as the blade is not exposed when fully retracted and as long as the defensive potential of the weapon is not severely limited. For example, the blade 31 may be about 1.0 inch to about 0.10 inch long. Preferably the blade is about 0.20 to about 0.90 inches in length. Even more preferable is a blade that is about 0.30 to about 0.80 inches in length.

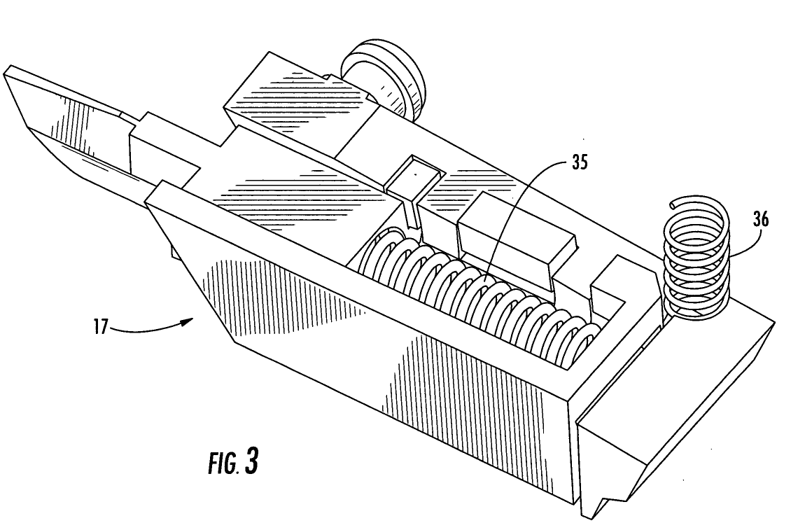

In the embodiment described above, the base 32 of the blade has a ridge 33 on one of its sides, which as already discussed, engages groove 20 located on sleeve 18. On the opposite side of the base from the ridge is a detent 34. Raising lever press 27 causes the locking lever assembly 19 to pivot about pivot point 28 lifting detents 25A and B in vertical slots 23A and 23B, respectively. By lifting detents 25A and B, detent 34 on the blade is allowed to slide beneath thereby allowing the retractable blade 13 to move freely within housing 17. The blade emerges from outer face 15 through slot 49, which is illustrated in FIG. 4. As base 32 slides forward within retractable blade housing 17 along groove 20, detent 34 engages stop 26, preventing blade 13 from sliding out of housing 17. The retractable blade is now in an open position. By lowering lever press 27, forward detent 25A prevents detent 34 from rearward movement, thus locking the retractable blade 13 in an open position. FIG. 3 illustrates a retractable blade housing 17 in accordance with one embodiment of the present invention with the retractable blade 13 locked in the open position. Retractable blade 13 is locked in a closed position in a similar manner. When retractable blade is slid to its most extreme rearward position, by lowering lever press 27, rear detent 25B prevents detent 34 from forward movement, thus locking the retractable blade 13 in a closed position.

The retractable blade housing 13 may additionally contain a spring 35 lying between rear surface of sleeve 18 and rear surface of the base 32 of the blade 13, as illustrated by FIGS. 2-4. When blade 13 is in a cocked position, spring 35 is coiled and loaded. Raising lever press 27 releases the retractable blade and spring 35 forces blade 13 open. The retractable blade housing may further contain locking spring 36, which applies downward vertical force to the lever press 27 (illustrated by FIGS. 2-4) thereby placing the locking lever assembly 19 in a locked position preventing retractable blade from moving within housing 13. Locking spring 36 may be a coiled spring such as the one depicted in FIGS. 2 and 3 or may be a flat spring 54 such as the one depicted in FIG. 4. Other types of springs may also be used and are well known in the art.

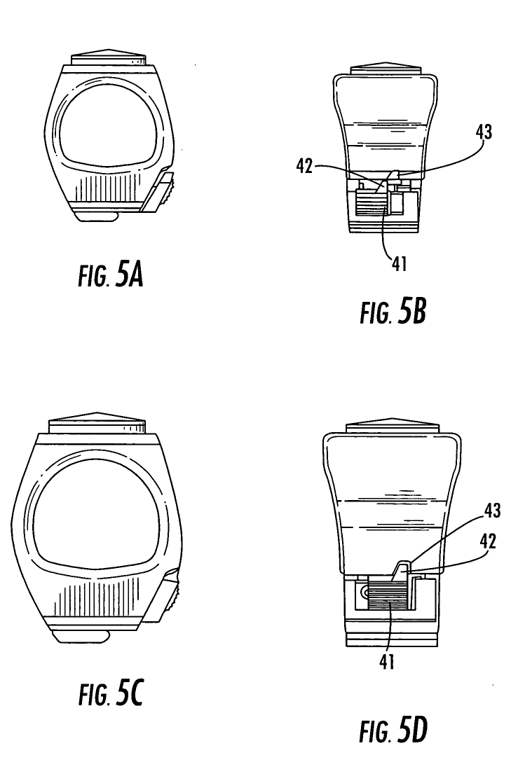

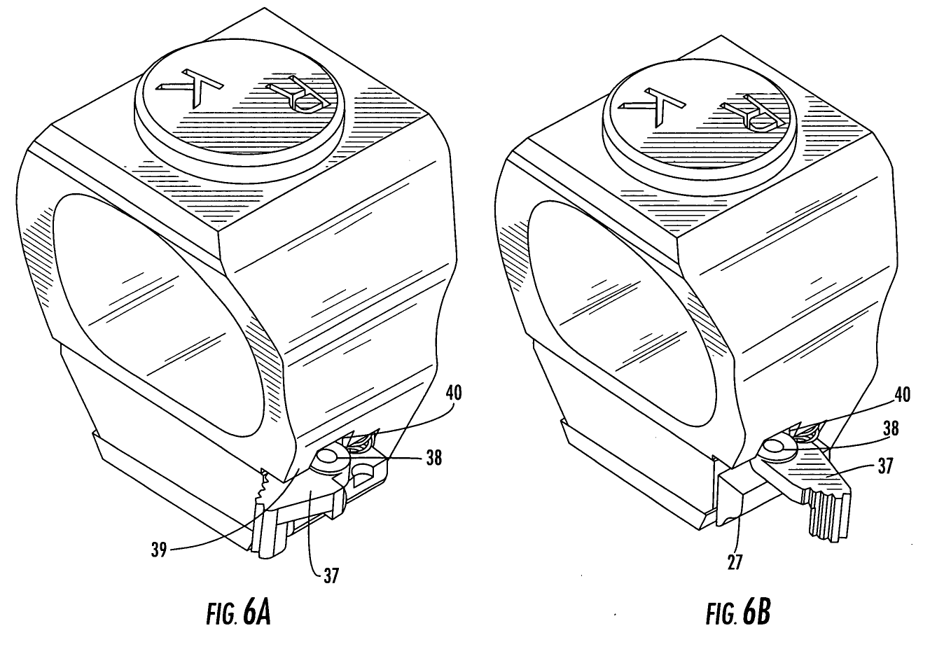

A safety may be included in the present invention to prevent inadvertent or unintentional deployment of the retractable blade. In one embodiment, the safety is in the form of a rotating safety lever 37 positioned and mounted to the top of lever press 27 at pivot 38. This embodiment is illustrated in FIG. 6. In this embodiment, pivot 38 is in the shape of a cylinder. When the safety is activated, lever 37 is positioned between lever press 27 and upper surface 39 of ring 10, thus preventing upward movement of lever press 27 and inadvertent deployment of the blade. In order to inactivate the safety, lateral pressure is applied to safety lever 37 at one end rotating safety lever about pivot 38. Directly above pivot 38 on upper surface 39 is a slot 40. When the lever has been rotated and safety inactivated, lever press 27 may then be pressed upward. As lever press moves in this direction, pivot 38 fits within slot 40 of upper surface 39. In an alternative embodiment, the safety is a slide lever design. This embodiment is illustrated in FIGS. 4-5. Slide lever 41 is slidably mounted to lever press 27. Slide lever 41 contains a detent 42 which engages a complementary slot 43 embedded within the surface 44 of ring 10 above the slide lever. When the safety is inactivated, detent 42 aligned with slot 43 allowing upward movement of lever press 27. When lateral pressure is exerted on slide lever 41, the slide lever moves along a defined path until detent 42 is no longer aligned with slot 43. At this point, lever press 27 is prevented from upward movement by the ring surface.

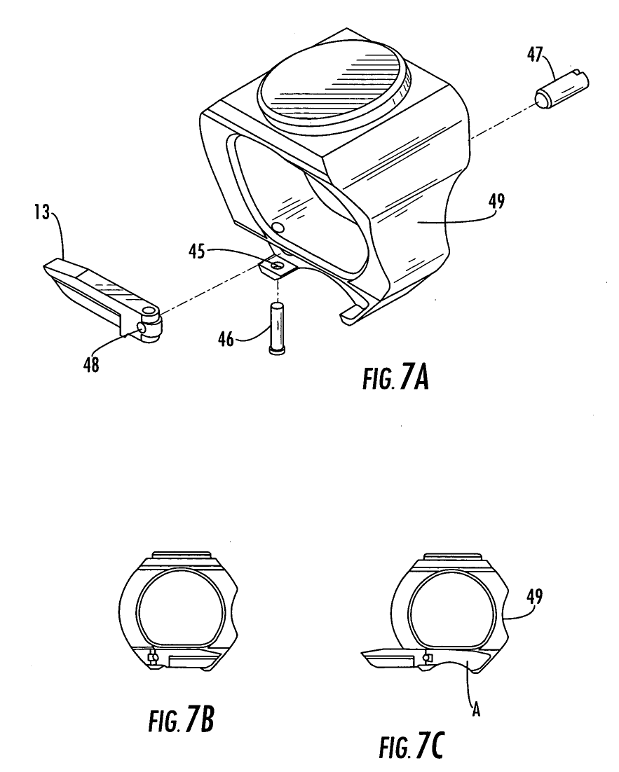

In alternative embodiment of the present invention, the retractable blade is a side-swinging design as illustrated in FIG. 7. In this embodiment, the blade is not housed within the base, as with the previously described embodiment, but is positioned external the base. In this embodiment, when in a closed position, the retractable blade is in contact with surface A of base 12, which is recessed for protection of the user. As retractable blade 13 opens it pivots about pivot point 45. Pivot point 45 may be defined by a screw or pin 46, which secures the blade to the surface of the ring and allows the blade to rotate about a fixed axis to effectively open and close the blade by rotating the blade around approximately 180 degrees. This retractable blade configuration may also have a locking mechanism which prevents the blade from retracting when in an open position or deploying when in a closed position. In one embodiment, blade 13 may be secured in place by a retractable pin or bearing 47 embedded within the surface of the ring. When blade 13 is deployed, bearing 47 engages aperture 48 on blade 13 securing the blade in place The ring of the present invention may also be equipped with a structure that stabilizes the ring and prevents rotation of the ring about the finger when the weapon is being used. In one embodiment, the ring 10 possesses a recessed surface 49 on the side of ring 10 nearest the ring finger of the user, as illustrated in FIG. 1. Recessed surface 49 allows the ring to fit comfortably against the ring finger while effectively stabilizing the ring and preventing the ring from spinning about the little finger. The ring is stabilized through the application of pressure by the ring finger on recessed surface 49 when the wearer clinches his fist. Other variants of stabilizing structures are also contemplated and useful for the intended purpose of preventing ring rotation about the little finger. For example, a double ring design similar to that described in U.S. Pat. No. 5,588,214 could also be used for stability.

Because it is desirable to cock a sharpened retractable blade without touching it in order to prevent possible injury caused by accidental laceration, the ring may additionally have a cock mechanism. In one embodiment shown in FIG. 4, the underside of base 12 has a slide lever 50 which is slidably mounted to the underside of base 12 by pin of screw 51. Pin 51 extends through a slot 52 extending lengthwise down the underside of base 12, into another slot extending lengthwise down the underside of sleeve 18 and into an aperture 53 on the bottom of blade base 32. When retractable blade 13 is in its open position and the wearer desires to cock the blade, the wearer may first push lever press 27 upward to unlock the blade 13 and subsequently apply lateral pressure to slide lever 50 thereby moving retractable blade 13 to a cocked position. Once retractable blade 13 is cocked, lever press 27 may be released and the safety may be activated to prevent accidental deployment.

The present ring and ring blade can be constructed from a variety of different materials, including metals, metal alloys, plastics, plastic polymers, or other suitably strong materials. For example, the ring blade may be constructed from stainless steel or titanium, however, other suitable metals or metal alloys are envisioned and may be used for the purposes of this invention.

Many modifications and other embodiments of the invention set forth herein will come to mind to one skilled in the art to which these inventions pertain having the benefit of teachings presented in the foregoing descriptions and the associated drawings. Therefore, it is to be understood that the inventions are not to be limited to the specific embodiments disclosed and that the modifications and other embodiments are intended to be included within the scope of the appended claims. Although specific terms are employed herein, they are used in a generic and descriptive sense only and not for purposes of limitation.

1. A device used in self defense comprising:
a ring adapted to be worn on the little finger of the user;
said ring having a base;
said base having a retractable blade that when fully deployed extends from the ring in a direction opposite from the ring finger of the user.

2. The device of claim 1, wherein said base further comprises a retractable blade housing mounted to said base that confines said retractable blade therein.

3. The device of claim 2, wherein said retractable blade housing further comprises a sleeve which cradles the retractable blade allowing said blade to slide freely therein.

4. The device of claim 2, wherein said retractable blade housing further comprises a locking lever assembly that locks the blade in extended and retracted positions.

5. The device of claims 1, wherein said base further comprises a safety to prevent accidental deployment of said retractable blade.

6. The device of claim 5, wherein said safety is a rotating lever.

7. The device of claim 5, wherein said safety is a slide lever.

8. The device of claim 1, wherein said retractable blade is a side swinging blade.

9. The device of claim 1, wherein said ring further comprises a stabilizing recess on its outer surface that decreases rotation of the ring on the finger.

10. The device of claim 1, wherein said base further comprises a cock mechanism allowing the user to retract the blade without touching the sharpened edge of the blade.

11. A device used in self defense comprising:
a ring adapted to be worn on the little finger of the user;
said ring having a base;
said base having a retractable blade housing mounted to said base and a retractable blade slidably mounted for movement within said retractable blade housing.

12. The device of claim 11, wherein said retractable blade housing comprises a sleeve which cradles the retractable blade allowing said blade to slide freely therein.

13. The device of claim 11, wherein said retractable blade housing comprises a locking lever assembly that locks the blade in extended and retracted positions.

14. The device of claim 11, wherein said base further comprises a safety to prevent accidental deployment of said retractable blade.

15. The device of claim 14, wherein said safety is a rotating lever.

16. The device of claim 14, wherein said safety is a slide lever.

17. The device of claim 11, wherein said ring further comprises a stabilizing recess on its outer surface that decreases rotation of the ring on the finger of the user.

18. The device of claim 11, wherein said base further comprises a cock mechanism allowing the user to retract the blade without touching the sharpened edge of the blade.

19. A device used in self defense comprising:
a ring adapted to be worn on the little finger;
said ring having a base;
said base having a retractable blade housing mounted to said base and a retractable blade slidably mounted for movement within said retractable blade housing;
said retractable blade housing having a sleeve which cradles the retractable blade allowing said blade to slide freely therein, and a locking lever assembly which interacts with retractable blade to deploy the blade and to lock the blade in extended and retracted positions.

20. The device of claim 19, wherein said retractable blade housing comprises a locking lever assembly which interacts with said retractable blade to deploy the blade and to lock the blade in extended and retracted positions.

21. The device of claim 19, wherein said base further comprises a safety to prevent accidental deployment of said retractable blade.

22. The device of claim 21, wherein said safety is a rotating lever.

23. The device of claim 21, wherein said safety is a slide lever.

24. The device of claim 19, wherein said ring further comprises a stabilizing recess on its outer surface that decreases rotation of the ring on the finger.

25. The device of claim 19, wherein said base further comprises a cock mechanism allowing the user to retract the blade without touching the sharpened edge of the blade.
